(19) United States
(12) Patent Application Publication
(10) Pub. No.: US 2002/0143505 A1
(43) Pub. Date: Oct. 3, 2002

(54) Implementing a finite state machine using concurrent finite state machines with delayed communications and no shared control signals

(76) Inventor: Doron Drusinsky, Cupertino, CA (US)

Correspondence Address: BURNS DOANE SWECKER & MATHIS L L P, POST OFFICE BOX 1404, ALEXANDRIA, VA, 22313-1404, US

(21) Appl. No.: 09/825,138

(22) Filed: Apr. 2, 2001

(51) Int. Cl. G06F 17/10

(52) U.S. Cl. 703/2

(57) ABSTRACT

The present invention comprises a method of implementing state machines between regions in which there are communication delays between the regions.

### BACKGROUND OF THE INVENTION

The present invention relates to the implementation of Finite State Machines. Finite State Machines are a popular way of implementing logic on Application Specific Integrated Circuits (ASICs) and Field Programmable Gate Arrays (FPGAs). In the finite state machine, a given state can transition into another state, depending upon the input to the finite state machine. Popular implementations of finite state machine use registers to store the state of the finite state machine with the feedback logic implemented as programmable logic.

### SUMMARY OF THE PRESENT INVENTION

If a finite state machine needs to control different regions of a system, state information delays between the regions can cause difficulties. If the states of the finite state machine are assigned to different regions, some of the transitions may require state information from a state in another region.

One embodiment of the present invention is a method for implementing a finite state machine in multiple regions with state-information communication delays between the regions. The method comprises assigning the states of the original finite state machine to the regions. The assignment resulting in border states which are states that can transition into a state other than in another region and adjacent states which are states that can, within a predetermined number of transitions, transition into a border state. The next step is implementing the new finite state machine in each of the multiple regions, a new finite state machine including the assigned states and additional states. At least one of the state of one of the new finite state machines transitions to another state when a communication delayed indication is received that another finite state machine in another region was in an adjacent state in a prior clock cycle and the finite state machine has a predetermined input history.

Another embodiment of the present invention comprises a method of implementing a finite state machine in multiple regions. The method comprising assigning states of an original finite state machine to the multiple regions and implementing new finite state machines in each of the multiple regions. The new finite state machines including the assigned states and at least one wait-state. At least one of the new finite state machines includes at least one duplicate state. The duplicate state being entered whenever a matching original state is entered in another of a new finite state machines. The original and duplicate states allowing state information to be divided into more than one region without relying on a communication of state information concerning the matching original state between the more than one region.

In this system, when the finite state machine is divided into multiple regions, the state which controls multiple elements in different regions is duplicated for each region. This prevents reliance on the communication of the entrance of the state from one region to the next region for control purposes.

### BRIEF DESCRIPTION OF THE DRAWINGS

FIG. 1 is a diagram of a reconfigurable chip used in one embodiment of the present invention.

FIG. 2 is a diagram of the operation of the reconfigurable slices in the reconfigurable fabric of FIG. 1.

FIG. 3 is a diagram of a finite state machine illustrating the assigning of states to multiple regions.

FIGS. 4A-4C illustrate a first step in implementing the new finite state machines for each of the regions of the original finite state machine of FIG. 3.

FIGS. 5A-5C illustrate modified state machines for the multiple regions modified to operate on delayed indications of adjacent states from an adjacent finite state machine as well as a predetermined input history.

FIGS. 6A-6C are diagrams that illustrate the addition of duplicate states to the finite state machines in the different regions so the duplicate states can control elements within the different regions without relying on communication between the states.

FIG. 7 illustrates an implementation of the finite state machines of FIGS. 6A-6C in multiple regions of the reconfigurable chip.

FIG. 8 illustrates the implementation of circuitry to provide the input history required for one embodiment of the system of the present invention.

FIG. 9 is a flow chart illustrating the operation of one method of the present invention.

FIGS. 10A and 10B are diagrams illustrating the method of constructing the transition logic for one embodiment of the system of the present invention.

### DETAILED DESCRIPTION OF THE PREFERRED EMBODIMENT

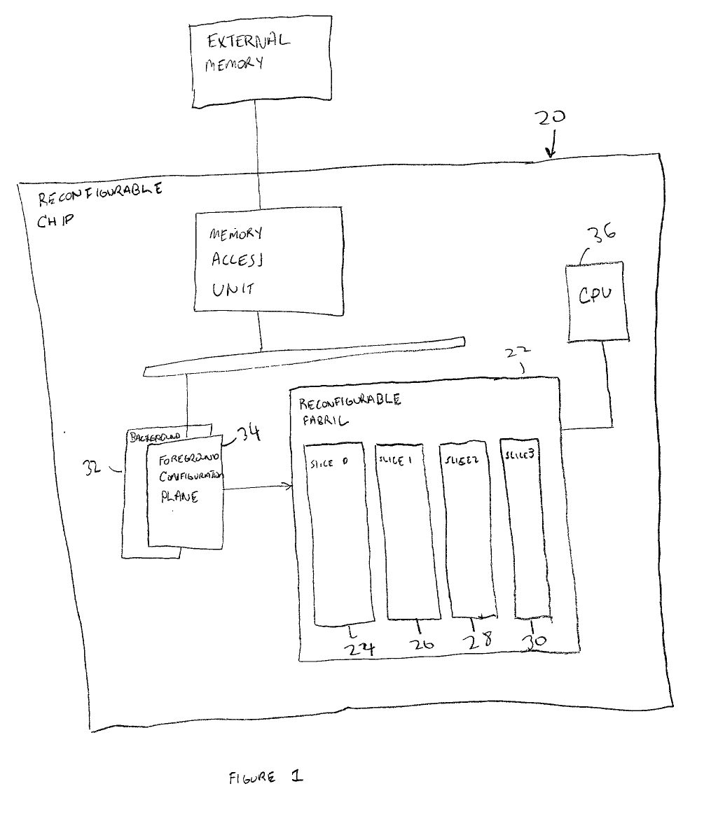

FIG. 1 is a diagram of a reconfigurable chip that can be used to implement the method of the present invention. The reconfigurable chip 20 includes a reconfigurable fabric 22. The reconfigurable fabric 22, is divided into different reconfigurable slices 24, 26, 28 and 30.

These reconfigurable slices include a number of configurable data path units, memory units and interconnect units. In one embodiment, the data path units include comparators, arithmetic logic units (ALUs) and registers which are configurable to implement operations of an algorithm on the reconfigurable chip. The reconfigurable slices also include dedicated elements such as multipliers and memory elements. The memory elements can be used for storing algorithm data. In one embodiment, associated with the data path elements in the reconfigurable fabric are control elements which can be implemented with a finite state machine. Looking again at FIG. 1, the integrated chip also includes configuration planes including a background configuration plane 22 foreground configuration plane 34. Configurations can be loaded into the background plane 32 and then moved to the foreground plane 34. The foreground plane 34 configures the element in every configurable fabric 22. Also shown on the reconfigurable chip is a CPU 36 which implements a portion of the algorithm.

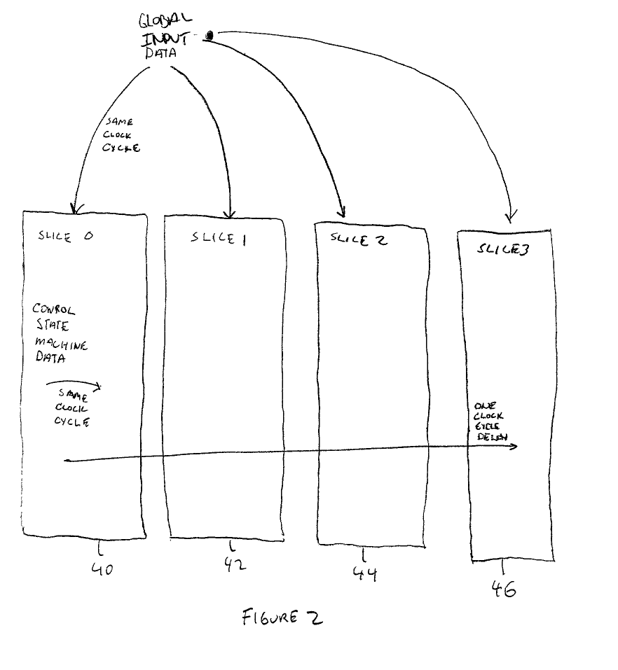

FIG. 2 illustrates a diagram of reconfigurable slice regions 40,42,44 and 46. Note that the control state machine in slice 40 is able to send an indication of the state within this same region during the same clock cycle. However, transferring the state information between the regions takes a clock cycle. As will be described below, this complicates the implementation of the finite state machines in each of the regions.

FIG. 3 illustrates a state machine 50. The original state machine 50 includes five states: S1, S2, S3, S4 and S5. In dividing the state machine into the different regions, different states of the original state machine are assigned to different regions. In this embodiment, states S1 and S2 are assigned to region 2, state S3 is assigned to region 1 and states S4 and S5 are assigned to region 3. Note that some of the states, states S2 and S3, control more than more than one data path unit in the different regions. The assignment of the states to the regions is preferably done such that the state controlling an element in a region is placed in the same region as the controlled unit. Some of the states control elements in more than one region, as will be described below. This problem is avoided by the use of duplicate states.

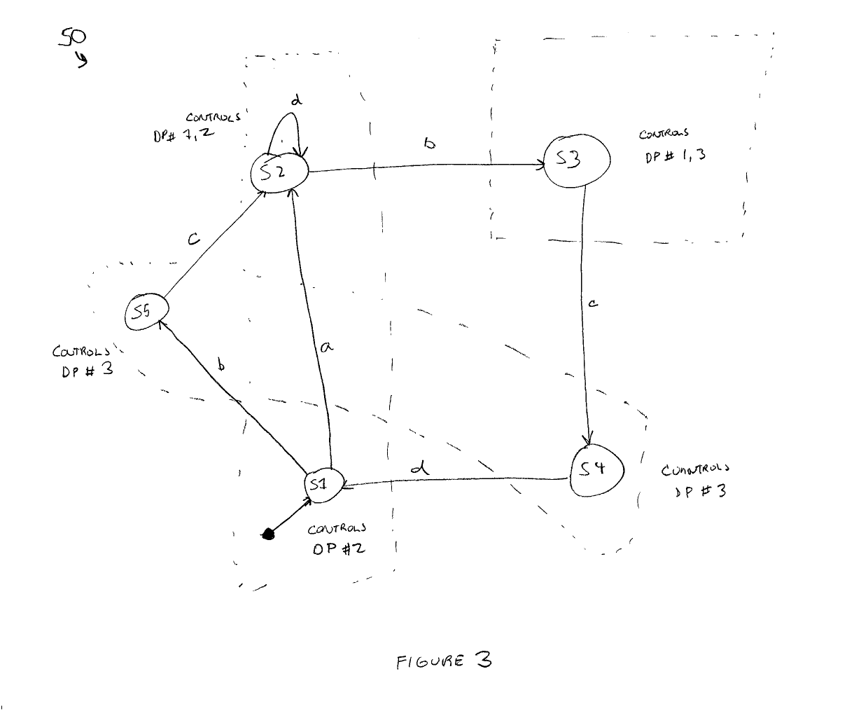

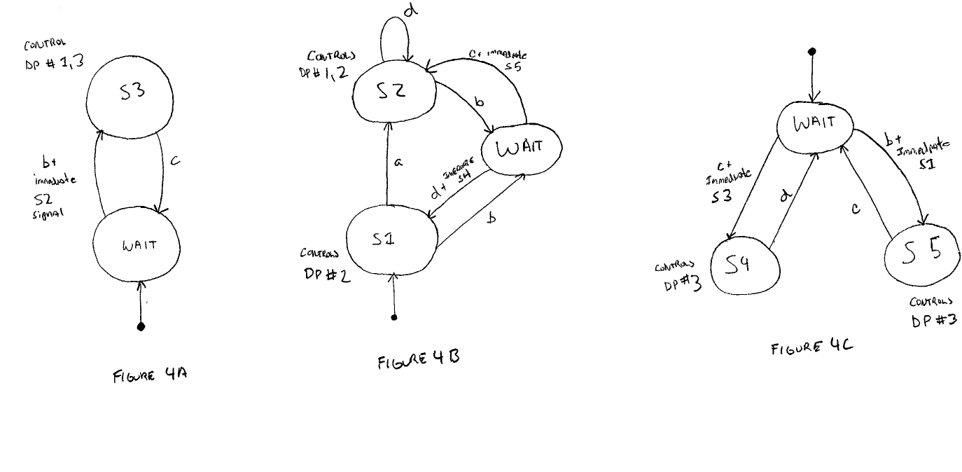

FIGS. 4A-4C illustrate a first attempt to split the original state machine in FIG. 3 into multi-state machines, one for each region. Looking at FIG. 4A, the state machine in FIG. 4A goes into the wait state until an indication that the current state is S2. This causes the system to transition into state S3 when a “c” signal is received. In the system of FIG. 4B, the state machine originally goes into state S1, and upon receiving an “a” signal, goes into state S2. Upon receiving a “b” signal, the finite state machine goes into the wait state. The “d” signal, when the state machine is in state S2, causes the system to remain in state S2. A “b” signal causes the finite state machine of FIG. 4B to transition from state S2 into the wait state. The system finite state machine leaves the wait-state into the state-S2 when a “c” signal and an immediate signal that the last state was state S5 is received. With a “d” signal and an immediate indication that the last state was S4, the finite state machine of FIG. 4B will transition from the wait state to state S1. The finite state machine in FIG. 4C is used for region 3. The transitions from the wait state to states-S4 and S5 are done based upon input information and indications of the previous state.

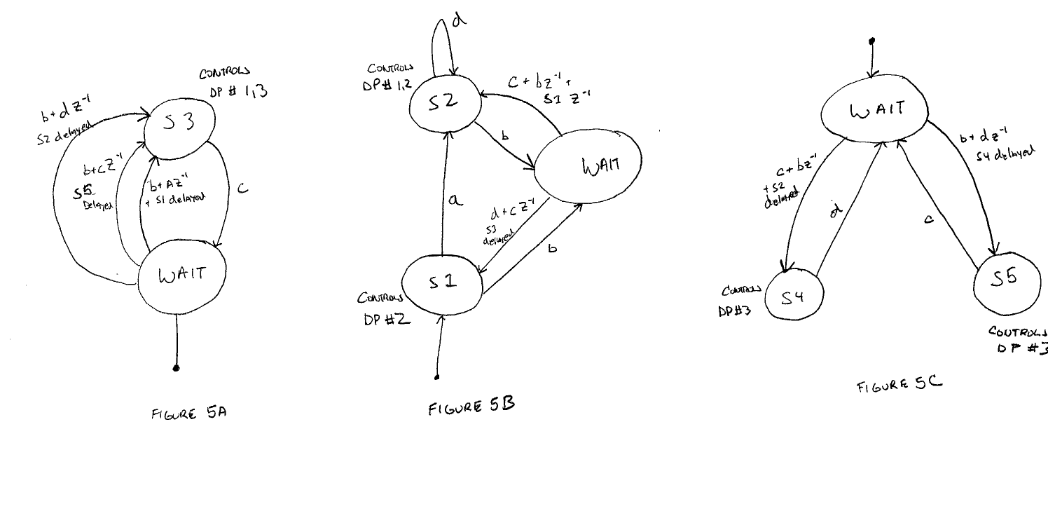

The system of FIG. 4 cannot be implemented when state information communication delays exist between the regions. Looking at FIG. 2, note that the communication of a state information from one slice to another slice has a clock delay. The immediate signals used to transfer out of the wait-state for the state machines in FIGS. 4A-4C, are not flexible. For this reason, the state machines FIGS. 4A-4C can be modified as shown in FIGS. 5A-5C. In this embodiment, the transitions out of the wait-state are replaced by the communication of the last two inputs to the state machine and the delayed state information.

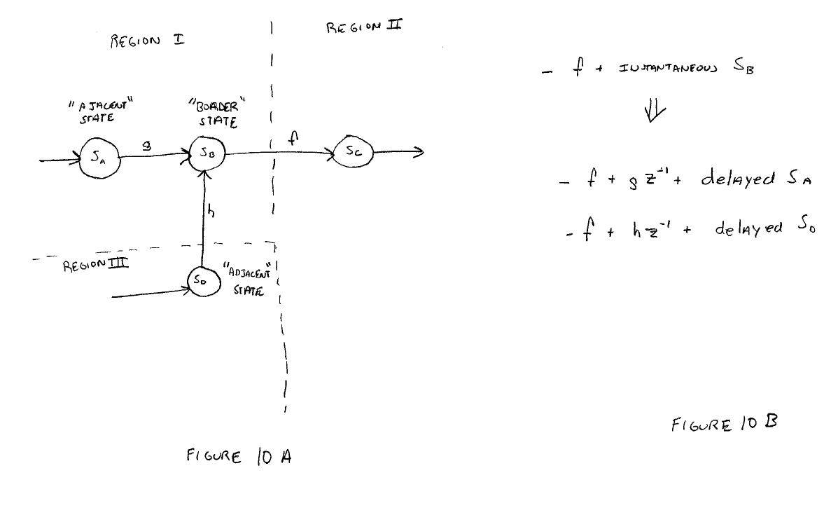

Details of this process are shown in FIGS. 10A-10B. In this embodiment within region I border state S_{B} can transition to another region II with the input f. Since the information that the finite state machine of region I is in state S_{B} cannot be transferred into region II quick enough, the transition rule can't rely on a non-delayed indication of the border state S_{B}, but use a delayed indication of the states adjacent to the border state, state S_{A} and state S_{B}. Thus, the state machine for region II, goes out of the wait state, when the current input is “f”, the last input is “g” and the delayed state is S_{A}. The use of the delayed state allows the state information to take a clock cycle to transfer between regions. An additional transition from state S_{A} occurs when the current input is “f”, the previous input is “h” and the delayed state is S_{D}.

Looking again at FIGS. 5A-5C, if it took even longer than a single clock cycle to transfer the state information between regions, an even further away adjacent state would have to be used, even more complicating the history and number of transitions from the wait state. Note that some of the transitions, such as in FIG. 5 the translation between the wait-state and state S2 use a delayed indication of a state which is in the state machine for that region. Thus, the indication for the translation between the wait-state and the state S2 cannot use the immediate state S2 indication, but must use a delay within or outside of the region. In one embodiment, all the state information is sent to a buffer which makes it available for every region in the next clock cycle.

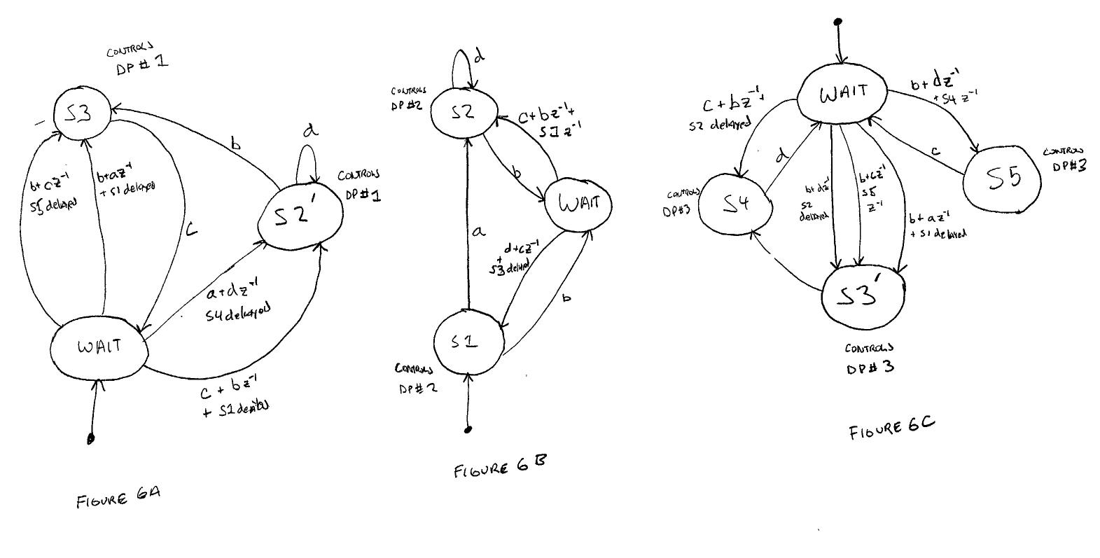

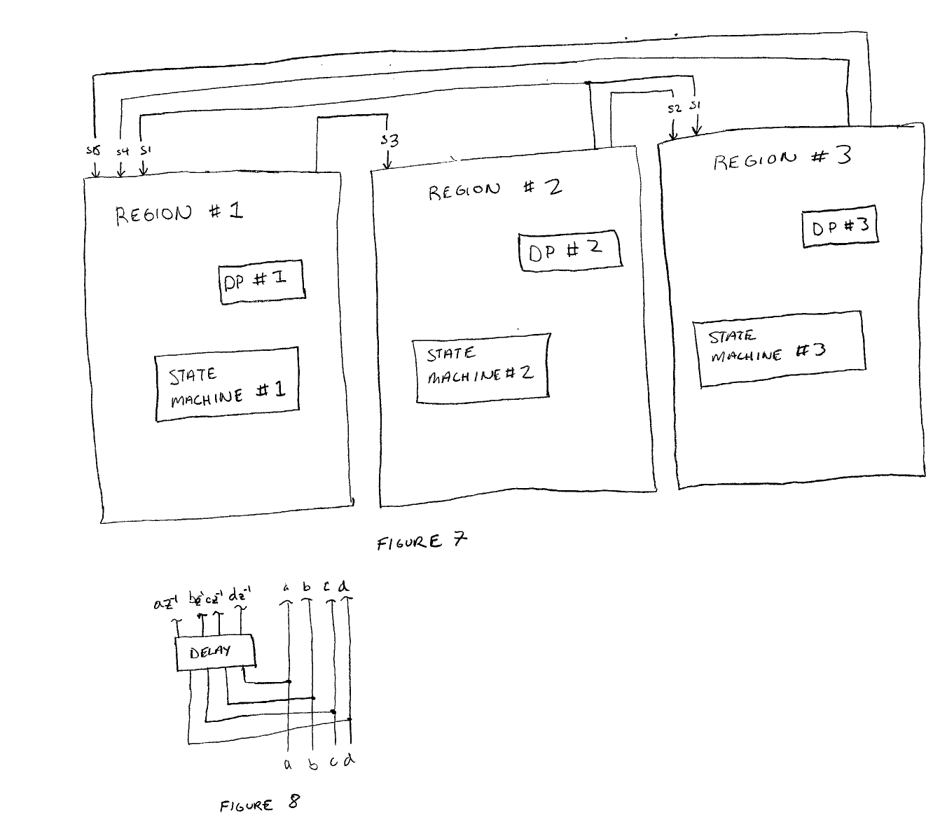

A disadvantage of the example shown in FIGS. 5A-5C is that states S3 and S2 still control elements in different regions from the state. FIGS. 6A-6C show the use of these duplicate states such as state S2′ added to the state machine of region 1 and state S3′ added to the state machine of region 3. These new duplicate states also have transitions out of the wait-state as well as transitions to the other states within the state machine for the region.

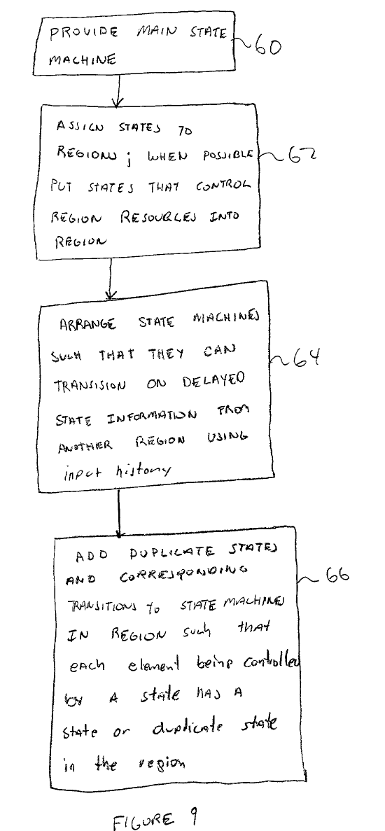

FIG. 7 illustrates an implementation which the state machines of FIGS. 6A-6C are implemented in region #1, region #2 and region #3. The data path unit #1 in region #1 can now be controlled only by the states within state machine #1. The data path unit #2 in state machine #2 are also controlled only by the states within state machine #2. The data path unit #3 in region #3 are also controlled only by the states in the state machine #3. Note that delayed state signals are sent between the different regions. FIG. 8 shows an implementation of how the delayed signals are produced. Each of the input signals a, b, c, d is sent to a delay to produce the delayed signal az⁻¹, bz⁻¹, cz⁻¹, dz⁻¹. Note that the delay of FIG. 8 is intentional, while the delay shown in FIG. 7 of the state signals is an inevitable delay of the system path. FIG. 9 is a flow chart illustrating the construction of the system in the present invention. In step 60, the main or original state machine is provided. In step 62, the states are assigned to different regions, when possible the states to control a region's resources are put in that region. In step 64, the state machines are arranged so that they can transition on a delayed state machine information from another region using the input history. This is described above with respect to FIGS. 10A and 10B. In step 66, duplicate states and the corresponding transitions are added to the state machines in the regions, such that the element being controlled by the state machine has a state or duplicate state in the region to control it. In this manner, no resources are controlled by a state of a finite state machine within a different region.

Appendix 1 contains additional descriptions of the system of the present embodiment.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

1. A method of implementing a finite state machine in multiple regions with state information communication delays between the regions, the method comprising:
assigning states of the original finite state machine to the multiple regions, the assignment resulting in “border” states which are states that can transition to a state in another region and “adjacent” states which are states that can, within a predetermined number of transitions, transition to a “border” state; and
implementing new finite state machines in each of multiple regions, the new finite state machines including the assigned states and additional states, wherein at least one state of one of the new finite state machines transitions to another state when a communication delayed indication is received that another new finite state machine in a different region was in an “adjacent” state in a prior clock cycle and the finite state machine has a predetermined input history.

2. The method of claim 1 wherein the implementation of the new finite state machines includes duplicate states that allow each element within a region to be controlled by a state within that region.

3. The method of claim 1 wherein the predetermined number is one.

4. The method of claim 3 wherein the communication delay for the state information between regions is approximately one clock cycle.

5. The method of claim 1 wherein the regions comprise slices on a reconfigurable chip.

6. The method of claim 1 wherein the finite state machines for the regions control that region on a reconfigurable chip.

7. A method of implementing a finite state machine in multiple regions, the method comprising:
assigning states of an original finite state machine to the multiple regions; and
implementing new finite state machines in each of the multiple regions, the new finite state machines including the assigned states and at least one wait state, wherein at least one of the new finite state machines includes at least one duplicate state, the duplicate state being entered whenever a matching original state is entered in another of the new finite state machines, the original and duplicate states allowing state information to be provided to more than one region without relying on a communication of state information concerning the matching original state between the more than one region.

8. The method of claim 7, wherein the state information provides control information for elements within the regions.

9. The method of claim 7 wherein there are state information communication delays between the regions.

10. Method of claim 9 wherein the transitions out of the wait-state are done by a delayed indication of the state in another region and a predetermined input history.

11. The method of claim 10, wherein the input history is the previous input to the original state machine.

12. The method of claim 7 wherein the regions comprise slices on a reconfigurable chip.

13. The method of claim 7 wherein the finite state machines implement control for the reconfigurable chip.
